(19) United States
(12) Patent Application Publication
(10) Pub. No.: US 2019/0177148 A1
(43) Pub. Date: Jun. 13, 2019

(54) BEVERAGE DISPENSING SYSTEM AND METHOD

(71) Applicant: Les Entreprises Cafection Inc., Quebec (CA)

(72) Inventors: Simon GAGNE, Levis (CA); Vincent Bouchard, Levis (CA); Yves Belzile, Neuville (CA); Oscar Enrique Bernal, Quebec (CA)

(73) Assignee: Les Entreprises Cafection Inc., Quebec (CA)

(21) Appl. No.: 16/216,029

(22) Filed: Dec. 11, 2018

Related U.S. Application Data
(60) Provisional application No. 62/597,122, filed on Dec. 11, 2017.

(51) Int. Cl. B67D 1/00

(52) U.S. Cl. CPC B67D 1/0042

(57) ABSTRACT

A system for dispensing a desired beverage, the system comprising: a housing; a dispensing unit disposed in the housing for dispensing the selected beverage; a first user interface for sighted users, the first user interface being secured to the housing and comprising a screen; a second user interface for visually impaired users, the second user interface being secured to the housing and comprising a plurality of buttons each associated with a respective command; and a control unit disposed within the housing and operatively connected to the dispensing unit and the first and second user interfaces, the control unit for operating the system in a first mode of operation in which commands are to be inputted via the first user interface and a second mode of operation in which the command are to be inputted via the second user interface.

### TECHNICAL FIELD

The invention relates to a beverage dispensing system and more particularly to a beverage dispensing system adapted for visually impaired users.

### BACKGROUND

Beverage dispensing systems are widely used as an automated solution to provide users and customers with desired beverages. Beverage dispensing systems encompass a wide variety of systems such as automatic beverage distributors such as those found in public places like cinemas or shopping malls which are adapted to prepare and/or provide a beverage selected from a plurality of beverages. Some beverage dispensing systems are adapted to provide a selected beverage at a specific temperature. For example, a beverage dispensing system may include coffee machines which are adapted to dispense coffee or other similar hot beverages to users. Alternatively, the beverage dispensing system may instead include a wine dispensing system or a beer dispensing system.

For visually impaired users, it is often difficult to use typical beverage systems, as they are void of any type of audio or touch instructions and feedback. For instance, beverage dispensing systems such as coffee machines tend to be void of such features which would enable visually impaired users to select and receive their coffee autonomously. This is especially true if the beverage system includes a touchscreen used to receive inputs from the user without providing feedback in return to indicate which option has been selected or which operation is being performed.

There is therefore a need for an improved beverage dispensing system which may overcome at least one of the above-identified drawbacks.

### SUMMARY

According to a broad aspect of the disclosure, there is provided a system for dispensing a desired beverage, the system comprising: a housing; a dispensing unit disposed in the housing for dispensing the selected beverage; a first user interface for sighted users, the first user interface being secured to the housing and comprising a screen; a second user interface for visually impaired users, the second user interface being secured to the housing and comprising a plurality of buttons each associated with a respective command; and a control unit disposed within the housing and operatively connected to the dispensing unit and the first and second user interfaces, the control unit for operating the system in a first mode of operation in which commands are to be inputted via the first user interface and a second mode of operation in which the command are to be inputted via the second user interface.

In one embodiment, the second user interface comprises an audio output unit for outputting vocal messages.

In one embodiment, wherein the audio output unit comprises at least one of an audio speaker and an audio connector for connecting an audio listening device.

In one embodiment, the second user interface comprises a plurality of braille characters written thereon, each one of the plurality of braille characters being associated with a respective one of the plurality of buttons.

In one embodiment, the second user interface comprises a plurality of symbols written thereon, each one of the plurality of symbols being associated with a respective one of the plurality of buttons.

In one embodiment, each one of the plurality of braille characters is superimposed on a respective one of the plurality of symbols.

In one embodiment, the control unit is configured for selectively operating the system in one of the first mode of operation and the second mode of operation.

In one embodiment, the control unit is configured for operating the system in the first mode of operation as a default mode and toggling in the second mode of operation upon activation of the second mode of operation.

In one embodiment, the control unit is configure for toggling in the second mode of operation upon detection that one of the plurality of buttons has been pressed.

In one embodiment, the control unit is configure for toggling in the second mode of operation upon detection that a predefined one of the plurality of buttons has been pressed.

In one embodiment, the control unit is configured for operating the system in the first mode of operation as a default mode and toggling in the second mode of operation upon detection that the audio listening device has been connected to the audio connector.

In one embodiment, when operated in the second mode of operation, the control unit is configured for providing an audio message via the audio output unit.

In one embodiment, the audio message prompt the user to make a desired selection.

In one embodiment, the audio message confirms a previous selection made by the user.

In one embodiment, the control unit is further configured for outputting a visual message on the screen.

In one embodiment, the plurality of buttons comprises a plurality of mechanical press buttons to provide tactile feedback to the user.

In one embodiment, the screen comprises a touchscreen.

In one embodiment, the housing further comprises a cup support disposed below the dispensing unit for receiving a beverage cup.

In one embodiment, the system further comprises a positioning sensor for detecting a presence of the beverage cup on the cup support.

In one embodiment, the plurality of buttons comprises at least some of a start button, a cancel button, a help button, at least one volume button, at least two cup size buttons and at least two beverage selection buttons.

### BRIEF DESCRIPTION OF THE DRAWINGS

Further features and advantages of the present invention will become apparent from the following detailed description, taken in combination with the appended drawings, in which:

FIG. 1 is a front right side perspective view of a beverage dispensing system, in accordance with one embodiment;

FIG. 2 is a front left side perspective view of the beverage dispensing system illustrated in FIG. 1;

FIG. 3 is a front view of a user input unit for the beverage dispensing system of FIG. 1; and

FIG. 4 is a flowchart showing a method for dispensing a beverage, in accordance with one embodiment.

### DETAILED DESCRIPTION

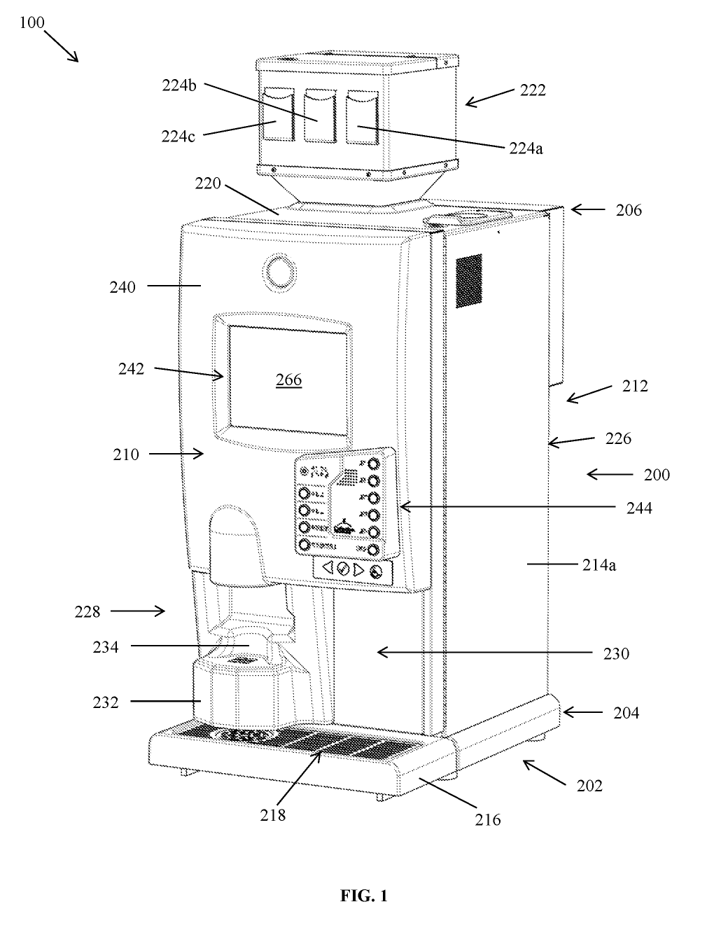

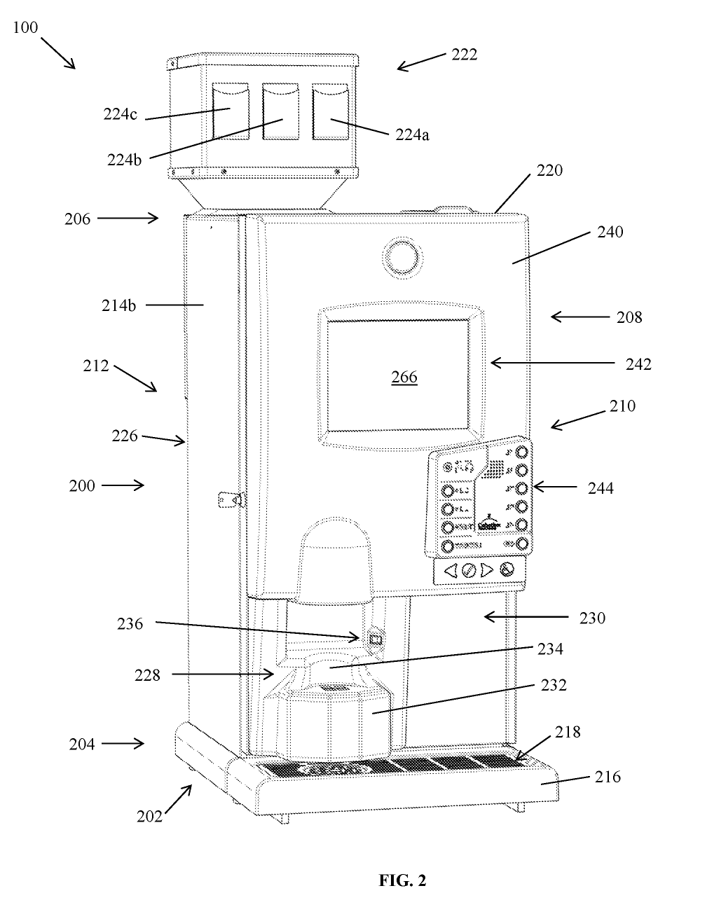

Referring first to FIGS. 1 and 2, there is illustrated one embodiment of a beverage dispensing system 100 adapted to provide a selected beverage to a user. The beverage dispensing system 100 may be operated into two different modes of operation: a first or sighted mode and a second or visually impaired mode.

In the illustrated embodiment, the beverage dispensing system 100 comprises a housing 200 adapted to store one or more beverages and/or ingredients to be mixed to provide a desired beverage to the user, a dispensing unit 228 received in the housing 200 for dispensing the desired beverage into a container such as a beverage cup, a user interface 210 for enabling a user to select a beverage to be dispensed and a control unit (not shown) for controlling the dispensing of the selected beverage.

In one embodiment, the beverage dispensing system 100 is configured to dispense hot beverages such as coffee, tea, soup, hot chocolate. It should be understood that the beverage dispensing system 100 could be configured to dispense any other type of beverage such as sodas, colas, beer, wine, water and/or the like.

In the illustrated embodiment, the housing 200 of the beverage dispensing system 100 has a generally elongated rectangular shape and has a lower end 204, a base 202 located at the lower end 204 and an upper end 206 opposite the base 202. The housing 200 further includes a front face 208 on which is located the user interface 210, a rear face 212 and a pair of side faces 214a and 214b.

In one embodiment, the base 202 is adapted to be positioned on a flat surface such as a table or a counter and comprises a waste recuperation compartment 216 having a drip tray 218 configured to recover beverage which may have spilled during dispensing or from a user grabbing the beverage cup.

In one embodiment, waste from the waste recuperation compartment 216 is conveyed to a storing tank or reservoir located within the housing 200 and may be emptied by a user.

In the illustrated embodiment, the upper end 206 of the housing 200 comprises a flat surface 220 onto which is mounted an ingredient container 222. Specifically, the ingredient container 222 is configured to store different ingredients into a plurality of receptacles 224a, 224b and 224c, each ingredient being mixed to a liquid for producing a beverage selectable by the user.

In one embodiment, the receptacles 224a, 224b and 224c are configured to store different types of coffee. Alternatively, it is contemplated that the receptacles may be configured to store any type of ingredient adapted to be mixed with a liquid, such as tea, powder chocolate, powder milk or the like.

In one embodiment, the ingredient container 222 may comprise a different number of receptacles for storing a different number of ingredient and therefore providing a different number of beverages to be dispensed to the user.

In one embodiment, the housing 200 comprises an electrical power cable (not shown) outwardly extending from a back wall 226 defined at the rear face 212 of the housing 200 and adapted to be plugged into a power outlet for powering the beverage dispensing system 100. The rear face 212 could further comprise a switch button for selectively activating and deactivating the beverage dispensing system 100 and at least one ventilation fan adapted to refresh the control unit of the beverage dispensing system 100. Alternatively, the housing 200 may be configured differently.

In one embodiment, the front face 208 of the housing 200 includes a front panel 240 which is pivotably mounted to side panel 214a for providing access to the interior of the housing 200. Alternatively, the housing 200 could include another access panel which is adapted to be opened to allow access to the interior of the housing 200.

In the illustrated embodiment, the beverage dispensing system 100 further includes a dispensing unit 228 located on the front face 208 of the housing 200 and operatively connected to the controller 300 for dispensing a beverage. Specifically, the dispensing unit 228 is located in a recess 230 extending from the front face 208 rearwardly towards the rear face 212.

The housing 200 further comprises a cup support 232 which is sized and shaped to receive a beverage container such as a beverage cup or the like. The cup support 232 is located in the recess 230 below the dispensing unit 228 to allow the cup received in the cup support 232 to receive the beverage dispensed by the dispensing unit 228. The cup support 232 extends upwardly from the base 202, over the drip tray 218, and comprises a concave curved face 234 for snuggly receiving the beverage cup. The dispensing unit 228 further comprises a positioning sensor 236 operatively connected to the control unit to provide positioning information to the control unit regarding the beverage cup relative to the cup support 232.

In one embodiment, the positioning sensor 236 may be of any type known to a person skilled in the art such as infra-red sensors, proximity sensors, capacitive or photoelectric sensors, mechanical sensor and the like.

In one embodiment, the front end 208 of the housing 200 further comprises a user interface 210 mounted to a front panel 240. The user interface assembly 210 is operatively connected to the control unit and comprises a first user interface 242 and a second user interface 244. The first user interface 242 may be any adequate user interface configured for sighted users to select a desired beverage. In the illustrated embodiment, the user interface 242 comprises a touchscreen 266 to be used by the sighted users to select the desired beverage. The control unit is configured for displaying options to the user on the touchscreen and for receiving selection commands from the touchscreen, as known in the art. The control unit is further configured for receiving selection commands from the second user interface 244.

In one embodiment, the beverage dispensing system 100 is provided with two modes of operation: a first or sighted mode of operation and a second or visually impaired mode of operation. When operated in the first mode of operation, commands are inputted via the first user interface 242, i.e. via the touchscreen 266. In this case, options such as predefined beverages, cup sizes and the like may be displayed on the touchscreen via texts, icons and/or the like, and the user inputs its selection (e.g., coffee type, cup size, milk, sugar, etc.) by touching the screen at the location corresponding to its choice such as by touching a displayed icon, as known in the art.

When operated in the second mode of operation, the commands are received by the control unit from the second user interface 244 as described in greater detail below.

In one embodiment, the beverage dispensing system 100 may be concurrently operated in the first and second modes of operation. In this case, the user may use any of the first and second user interfaces 242 and 244 to input commands. For example, the user may select a beverage type using the first user interface 242 and a cup size using the second user interface 244.

In another embodiment, the beverage dispensing system 100 may selectively be operated in the first or the second mode of operation. In this case, the user selects one of the two user interfaces and inputs all of his commands/selections using the selected user interface 242, 244.

In one embodiment, the beverage dispensing system 100 is in a default mode of operation associated with a default user interface and the user has to select the other mode of operation if he does not want to use the user interface associated with the default mode of operation. For example, the default mode of operation of the beverage dispensing system 100 may be the first mode of operation. Therefore, if he wants to use the second user interface 244 to operate the beverage dispensing system 100 in the second mode of operation, a user has to select the second user interface. As described above, the second mode of operation may be selected by interacting with the second user interface 244.

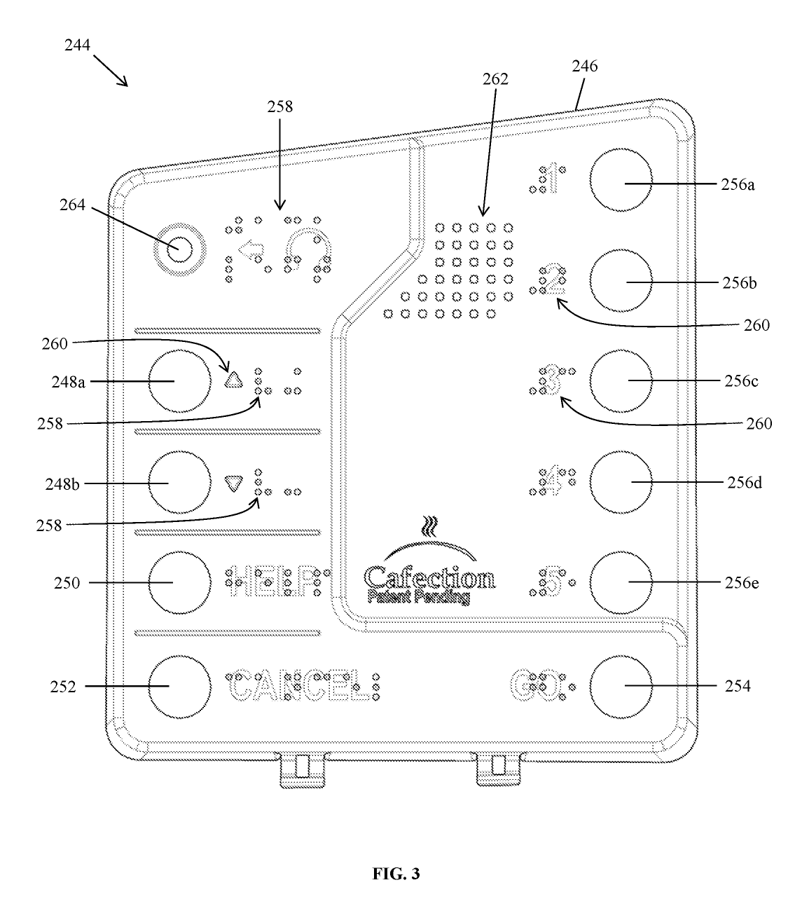

FIG. 3 illustrates one embodiment for the user interface 244. In this embodiment, the user interface 244 comprises a control box 246 having a plurality of buttons such as mechanical press buttons for operating the beverage dispensing system 100 for dispensing a selected beverage in the second mode of operation. In this configuration, the buttons are located on the front face of the control box 246 and comprise volume buttons 248a, 248b, a help button 250, a cancel button 252, a start or go button 254 and beverage selection buttons 256a, 256b, 256c, 256d and 256e. It should be understood that the characteristics of the buttons, such as the number, position, shape, size and/or the like of buttons, and the functions/commands associated with the buttons are exemplary only.

The user interface 244 is further provided with an audio speaker 262 for providing vocal/oral information to the user. For example, the audio speaker 262 may be used for providing vocal instructions and/or feedback to the user.

One or more braille characters 258 are written on the front face of the control box 146. In one embodiment, a braille character 258 indicative of the function/command associated with a respective button is written adjacent to its respective button in order to inform a visually impaired user of the function/command associated For instance, the braille characters 258 may inform on the type of coffee or beverage to be dispensed, on a volume setting, on a cancellation action and the like.

In one embodiment, visual symbols 260 are further provided on the user interface 244. Each visual symbol 260 is associated with a respective button and correspond to a visual representation of the function/command associated with its respective button. Each visual symbol 260 is located on the front face of the control box 246 adjacent to its respective button. In one embodiment, the visual symbol 260 associated with a given button may be superposed to the braille characters 258 associated with the same given button. In one embodiment, the visual symbols 260 allow sighted users to operate the beverage dispensing system 100 while using the second user interface 244.

In one embodiment, the user interface 244 further comprises an audio cable outlet or audio connector 264 located on front face of the control box 246 for connecting an audio listening device such as earphones or headphones. A braille character 258 is associated with the audio cable outlet 264 and written adjacent to the audio cable outlet 264 for informing a visually impaired user of the presence of the audio cable outlet 264. In one embodiment, a visual symbol 260 is also associated with the audio cable outlet 264 and positioned adjacent to the audio cable outlet 264. In one embodiment, the braille character 258 associated with the audio cable outlet 264 is superimposed on the visual symbol 260 associated with the audio cable outlet 264. Once earphones or a headphone is connected to the audio cable outlet 264, vocal information may be provided to the user via the audio cable outlet 264. For example, vocal instructions and/or vocal feedback may be provided to the user.

In an embodiment in which the beverage dispensing system 100 is used in the second mode of operation, i.e. when the second user interface 244 is used for selecting a beverage, the first user interface 242 may be used for providing visual information to limited sight users. In this case, information may be displayed on the screen 266 of the first user interface 242. For example, the control unit may modify the size of characters, icons, symbols, and/or the like displayed on the screen 266 in comparison to the information displayed thereon when the beverage dispensing system 100 is operated in the first mode of operation. In the same or another example, the contrast of the screen 266 may be increased in comparison to when the beverage dispensing system 100 is operated in the first mode of operation in order to help a limited sight user visualizing the information displayed on the screen 266.

In an embodiment in which visual information is displayed on the screen 266 while the beverage dispensing system 100 is operated in the second mode of operation, audio information may also be provided to the user via the audio speaker 262 or the audio cable outlet 264.

The person skilled in the art will appreciate that in the case of a beverage dispensing system 100 for dispensing coffee for example, the housing 200 may be adapted to store a water tank for receiving water, a brewing unit for mixing coffee from the ingredient container with water from the water tank, a thermoblock and a temperature sensor for heating the water, a filter for filtering the coffee as it is mixed with the water, a flowmeter for providing an appropriate amount of beverage to the beverage cup according to the size of the cup specified by the user and a pump for conveying the beverage to the dispensing unit 228. In this embodiment, the brewing unit, the thermoblock, the temperature sensor, the flowmeter and/or the pump may be operatively connected to the control unit.

In one embodiment, the control unit comprises at least one processing unit or processor and a memory or storing unit, and is in communication with the first and second user interfaces 242 and 244. When the beverage dispensing system 100 is operated in the first mode of operation, the control unit is configured for receiving commands from the first user interface 242 and operate the beverage dispensing system 100 according to the received commands. The control unit may further be configured for displaying information on the screen 266 of the first user interface 242. The information

The control unit is further in communication with at least some other components of the beverage dispensing system 100 in order to prepare and deliver a selected beverage. The instructions for preparing the beverages may be stored on the memory of the control unit and the control unit may instruct the other components according to the instructions stored on the memory in order to prepare the beverages. In an embodiment in which the beverage dispensing system 100 comprises a positioning sensor 236, the control unit is configured for receiving information about the positioning of a cup from the positioning sensor 236. If the received information is indicative of a correct positioning for the cup, the control unit then operates the beverage delivering system 100 so as to prepare and deliver the beverage selected by the user. However, if the information received from the positioning sensor indicates that the cup is not adequately positioned or no cup has been positioned, then the control unit may prevent the preparation and delivery of the selected beverage. Furthermore, the control unit may provide feedback information to inform the user that the cup has not been adequately positioned or no cup has been positioned. When the beverage dispensing system 100 is operated in the first mode of operation, the control unit may display information on the screen 266 for example. When the beverage dispensing system 100 is operated in the second mode, the control unit may provide audio feedback information via the audio speaker 262 or the audio cable outlet 264. Optionally, the control unit may further provide visual feedback information on the screen 266.

As described above, the beverage dispensing system 100 may concurrently be operated in the first and second modes of operation. In this case, the control unit executes any command coming from the first user interface 242 or the second user interface 244. For example, a first command indicative of a type of beverage may be received from the first user interface 242 while a second command indicative of a size cup may be received from the second user interface 244. In this case, the control unit then controls the required components of the beverage dispensing system 100 to dispense the selected beverage.

In another embodiment, the beverage dispensing system 100 may selectively operate in either the first mode of operation or the second mode of operation. If the beverage dispensing system 100 is operated in the first mode of operation, then a user should input commands via the first user interface 242. In the first mode of operation, the control unit controls the touchscreen 266 so as to display information thereon. The information is indicative of the possible choices for the beverages to be dispensed. A user may then select a desired beverage and input at least one command by touching the screen, as known in the art. In this mode of operation, the control unit may provide visual feedback information to a user by displaying information of the touchscreen 266. For example, the control unit may display on the touchscreen 266 a message indicative that the cup has not been adequately positioned. In one embodiment, the first mode of operation in which commands are inputted via the touchscreen 266 of the first user interface 242 is particularly suited for sighted users.

If the beverage dispensing system 100 is operated in the second mode of operation, then a user should use the second user interface 244 to input commands. In one embodiment, the second user interface 244 comprises push buttons and each time a button is pressed or pushed, a command is sent to the control unit. In this mode, the control unit is configured for preparing and delivering a beverage according to the commands received from the second user interface 244. The control unit is further configured for providing audio information to the user via the audio speaker 262 or the audio cable outlet 264. In one embodiment, the audio information comprises feedback information to confirm a selection or command inputted by the user and/or information for guiding the user in the next step. As described above, the control unit may further be configured for also providing the user with visual feedback information on the screen 266 in addition to the audio information. In this case, the size of the displayed information is greater than that of the information displayed in the first mode of operation and/or the contrast of the screen 266 in comparison to the contrast used in the first mode of operation. For example, the visual information displayed on the screen 266 may be indicative of a command inputted by the user or may help the user with the next step.

In one embodiment, the beverage dispensing system 100 operates in a default mode of operation, e.g. the first mode of operation, and the second mode of operation has to be activated to be able to input commands using the second user interface 244. In one embodiment, the second mode of operation in which commands may be inputted via the second user interface 244 may be activated by pressing a button of the second user interface 244. In one embodiment, pressing any button of the second user interface 242 allows toggling into the second mode of operation. In another embodiment, a specific button should be pressed to toggle the beverage dispensing system 100 in the second mode of operation. For example, the specific button may be the start button 254 or a dedicated button. In one embodiment, the beverage dispensing system 100 may toggle from the default mode of operation, e.g. the first mode of operation, to the other mode of operation, e.g. the second mode of operation, by inserting an audio connector into the audio cable outlet 264. It should be understood that any adequate method for detecting the insertion of an audio connector into the audio cable outlet 264 may be used by the control unit.

For example, while being in the default mode of operation, e.g. the first mode of operation, the control unit expects receiving commands from the first user interface 242. In an embodiment in which the depression of any button of the second user interface allows toggling from the first mode of operation to the second mode of operation, the control unit, while operating in the first mode of operation, interprets any signal coming from the second user interface 244 as being a command to switch the mode of operation mode. However, if a specific button, e.g. the start button 254, has to be pressed to activate the second mode of operation while the beverage dispensing system 100 operates in the first mode of operation, the control unit would ignore any incoming signal indicating that a button other than the specific button has been pressed and would continue operating the beverage dispensing system 100 in the first mode of operation.

In the following, there is described an exemplary method for operating the beverage dispensing system 100. However, the person skilled in the art would understand that other methods may be envisioned.

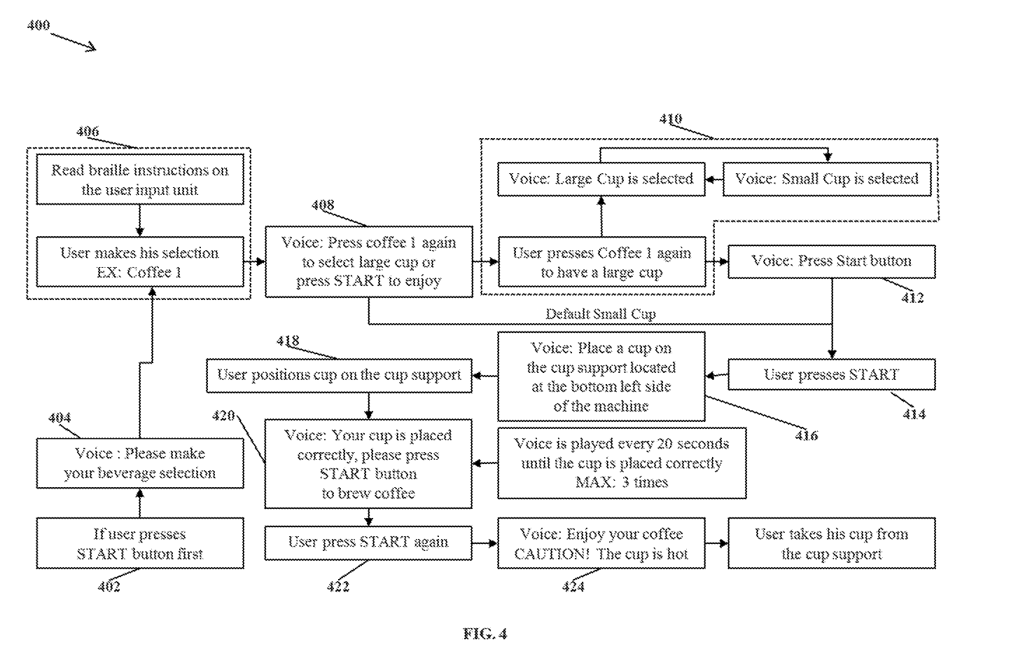

FIG. 4 illustrates one embodiment of a method 400 for dispensing a beverage using the beverage dispensing system 100.

In this embodiment, the beverage dispensing system 100 is provided with a default mode of operation, i.e. the first mode of operation in which the first user interface is to be used to input commands. Before step 402, the beverage dispensing system 100 operates in its default mode of operation. Still in this embodiment, the start button 254 of the second user interface 244 should be pressed in order to operate the beverage dispensing system 100 in the second mode of operation.

At step 402, a user such as a visually impaired user presses on the start button 254 of the second user interface 244 to initiate the selection of a beverage. The actuation of the button 254 triggers the transmission of a signal to the control unit which toggles into the second mode of operation since the button 254 has been actuated.

At step 404, the control unit outputs via the audio speaker 262 or the audio cable outlet 264, an audio message to the user to prompt the user to make a beverage selection. In one embodiment, the control unit may concurrently display a message on the screen 266 to prompt the user to make a beverage selection. In one embodiment, the font used for the displayed message may be increased and/or the contrast of the screen 266 may be increased.

At step 406, the user reads the braille characters 258 located next to the beverage selection buttons and makes a selection of a desired beverage to be dispensed and presses the button corresponding to his selection. The control unit then receives the selection made by the user by identifying the given button that was pressed by the user.

After receiving the beverage selection, the control unit outputs via the audio speaker 262 or the audio cable outlet 264, an audio message prompting the user to either press start or press the same button to change the cup size. In the present embodiment, a default cup size is set, and the cup size may be changed by the pressing the same button that was pressed at step 406. More precisely, in the illustrated embodiment, the default cup size is a small cup and only two cup sizes are available, namely, a small cup size and a large cup size. In one embodiment, the control unit may concurrently display a message on the screen 266 to prompt the user to either press start or press the same button to change the cup size. In one embodiment, the font used for the displayed message may be increased and/or the contrast of the screen 266 may be increased.

If he wants a small size beverage, the user presses the start button 254 at step 414.

If he wants a large size beverage, the user presses at step 410 the same button as the one pressed at step 406. The control unit then receives a signal from the second user interface 244 indicating that the same button has been pressed a second time and interprets this signal as a change of cup size to a large cup size. The cup size if then changed to a large size and the control unit outputs via the audio speaker 262 or the audio cable outlet 264, an audio message indicating the selected cup size. If the user presses again the button that was pressed at step 406, the selected cup size returns to the small size and a message indicating a small cup size has been selected is outputted via the audio speaker 262 or the audio cable outlet 264. By pressing a further time on the same button, the selection goes back to the large cup size, etc. It should be understood that the control unit may also display a message indicating the selected cup size on the display 266 with optionally increased font characters and/or an increased contrast.

After receiving a signal indicative of the selected cup size and having outputted a message indicative of the selected cup size, the control unit outputs at step 412 an audio message prompting the user to press the start button 254 via the audio speaker 262 or the audio cable outlet 264. It should be understood that the control unit may also display a message prompting the user to press the start button 254 on the display 266 with optionally increased font characters and/or an increased contrast.

As the start button 254 is actuated by the user, the control unit receives at step 414 a signal indicative of the actuation of the start button 254 form the second user interface 244 and outputs at step 416 an audio signal informing the user to place a cup on the cup support via the audio speaker 262 or the audio cable outlet 264. It should be understood that the control unit may also display a message prompting the user to place a cup on the cup support on the display 266 with optionally increased font characters and/or an increased contrast.

If the user then places a cup on the cup support, the sensor 236 detects the cup and optionally its adequate position on the cup support. At step 418, the control unit receives from the sensor 236 a signal indicating that a cup has been placed on the cup support and outputs at step 420 an audio signal informing that a cup has been adequately placed on the cup support and prompting the user to press the start button 254, via the audio speaker 262 or the audio cable outlet 264. It should be understood that the control unit may also display a message on the display 266 with optionally increased font characters and/or an increased contrast.

If the user places no cup on the cup support or misplaces the cup on the cup support, the sensor 236 detects no cup or detects that the cup is not adequately placed. In this case, the control unit receives from the sensor 236 a signal indicating that a cup has not been correctly placed on the cup support and outputs again the message outputted at step 416.

In an embodiment in which the sensor 236 detects that the cup has not been correctly place or that no cup has been placed on the cup support, the control unit may output the same message as the one outputted at step 416 a given number of times, e.g. three times as in the illustrated embodiment. Alternatively, this message may be outputted until the user correctly places a cup on the cup support.

Once a cup has been adequately placed on the cup support, the control unit outputs at step 420 an audio signal prompting the user to press the start button 254, via the audio speaker 262 or the audio cable outlet 264. It should be understood that the control unit may also display a message prompting the user to press the start button 254 on the display 266 with optionally increased font characters and/or an increased contrast.

In one embodiment, the signal outputted at step 420 may also inform the user that the cup has been correctly placed.

The user then presses the start button 254. At step 422, the control unit receives a signal indicating that the start button 254 has been pressed and interprets the signal as a command to prepare and dispense the selected beverage according to the selected cup size. The control unit then sends a command indicative of the selected beverage and size to the dispensing unit 228 which dispenses the beverage into the cup placed on the cup support.

In one embodiment, the control unit may further output at step 424 an audio message thanking the user and/or telling the user to enjoy his beverage, via the audio speaker 262 or the audio cable outlet 264. It should be understood that the control unit may also display a message on the display 266 with optionally increased font characters and/or an increased contrast. In an embodiment in which the user has selected a hot beverage, the message may further warn the user that the beverage is hot.

While the above description refers to two available cup sizes, it should be understood that the beverage dispensing system 100 may provide one than two cup size options. For example, the beverage dispensing system 100 may offer three different cup sizes: a small cup, a medium cup and a large cup. In this case, the desired cup size may still be selected at step 410. For example, the default cup size may be the small size so that at step 410 the medium cup size may be selected by pressing once on the button pressed at step 406 and the large cup size may be selected by pressing twice on the button pressed at step 406.

In one embodiment, the second user interface 244 may further comprise at least two additional buttons each associated with a respective cup size. In this case, the control unit may be configured for outputting a message prompting the user to select a desired cup size and press on the respective button. The control unit then receives from the second user interface 244 a signal indicative of the given button that was pressed by the user and prepare the selected beverage according to the selected cup size.

It should be understood that some of the above steps may be omitted. For example, the step 424 may be omitted.

It should also be understood that the order may be changed. For example, the steps 416-420 related to the positioning of a cup on the cup support may be performed prior to step 404.

While in the above method 400, the start button 254 is used for triggering the second mode of operation at step 402, it should be understood that other methods for triggering the activation of the second mode of operation may be used as described above.

The embodiments of the invention described above are intended to be exemplary only. The scope of the invention is therefore intended to be limited solely by the scope of the appended claims.

1. A system for dispensing a desired beverage, the system comprising:
a housing;
a dispensing unit disposed in the housing for dispensing the selected beverage;
a first user interface for sighted users, the first user interface being secured to the housing and comprising a screen;
a second user interface for visually impaired users, the second user interface being secured to the housing and comprising a plurality of buttons each associated with a respective command; and
a control unit disposed within the housing and operatively connected to the dispensing unit and the first and second user interfaces, the control unit for operating the system in a first mode of operation in which commands are to be inputted via the first user interface and a second mode of operation in which the command are to be inputted via the second user interface.

2. The system of claim 1, wherein the second user interface comprises an audio output unit for outputting vocal messages.

3. The system of claim 2, wherein the audio output unit comprises at least one of an audio speaker and an audio connector for connecting an audio listening device.

4. The system of claim 1, wherein the second user interface comprises a plurality of braille characters written thereon, each one of the plurality of braille characters being associated with a respective one of the plurality of buttons.

5. The system of claim 4, wherein the second user interface comprises a plurality of symbols written thereon, each one of the plurality of symbols being associated with a respective one of the plurality of buttons.

6. The system of claim 4, wherein each one of the plurality of braille characters is superimposed on a respective one of the plurality of symbols.

7. The system of claim 1, wherein the control unit is configured for selectively operating the system in one of the first mode of operation and the second mode of operation.

8. The system of claim 7, wherein the control unit is configured for operating the system in the first mode of operation as a default mode and toggling in the second mode of operation upon activation of the second mode of operation.

9. The system of claim 8, wherein the control unit is configure for toggling in the second mode of operation upon detection that one of the plurality of buttons has been pressed.

10. The system of claim 9, wherein the control unit is configure for toggling in the second mode of operation upon detection that a predefined one of the plurality of buttons has been pressed.

11. The system of claim 3, wherein the control unit is configured for operating the system in the first mode of operation as a default mode and toggling in the second mode of operation upon detection that the audio listening device has been connected to the audio connector.

12. The system of claim 2, wherein when operated in the second mode of operation, the control unit is configured for providing an audio message via the audio output unit.

13. The system of claim 12, wherein the audio message prompt the user to make a desired selection.

14. The system of claim 12, wherein the audio message confirms a previous selection made by the user.

15. The system of claim 12, wherein the control unit is further configured for outputting a visual message on the screen.

16. The system of claim 1, wherein the plurality of buttons comprises a plurality of mechanical press buttons to provide tactile feedback to the user.

17. The system of claim 1, wherein the screen comprises a touchscreen.

18. The system of claim 1, wherein the housing further comprises a cup support disposed below the dispensing unit for receiving a beverage cup.

19. The system of claim 18, further comprising a positioning sensor for detecting a presence of the beverage cup on the cup support.

20. The system of claim 1, wherein the plurality of buttons comprises at least some of a start button, a cancel button, a help button, at least one volume button, at least two cup size buttons and at least two beverage selection buttons.
